(19) United States
(12) Patent Application Publication
(10) Pub. No.: US 2007/0040965 A1
(43) Pub. Date: Feb. 22, 2007

(54) REFLECTIVE LIQUID CRYSTAL ON SILICON PANEL AND PROJECTION DISPLAY APPARATUS USING THE SAME

(76) Inventors: Da-Shuang Kuan, Hsinchu County (TW); Tony Whitehead, Hsinchu City (TW); Chi-Tai Meng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,850

(22) Filed: Aug. 19, 2005

(51) Int. Cl. G02F 1/1335

(52) U.S. Cl. 349/113

(57) ABSTRACT

A reflective liquid crystal on silicon (LCOS) panel including a silicon substrate, an absorption layer, a color mirror, a transparent substrate and a liquid crystal layer is described. The silicon substrate has a pixel array thereon. The absorption layer is disposed over the pixel array. The color mirror is disposed over the absorption layer, and the color mirror reflects light having at least a predetermined range of wavelength and light not reflected by the color mirror is absorbed by the absorption layer. The transparent substrate having a transparent electrode thereon is disposed opposite to the silicon substrate. The liquid crystal layer is disposed between the color mirror and the transparent electrode.

### BACKGROUND OF THE INVENTION

1. Field of the Invention

The present invention generally relates to a liquid crystal panel and a display apparatus. More particularly, the present invention relates to a reflective liquid crystal on silicon (LCOS) panel and a projection display apparatus using the same.

2. Description of Related Art

In recently years, since the liquid crystal display (LCD) has the advantages being compact, flat, light weight, low operation voltage, low power consumption and radiation free, the conventional cathode ray tube (CRT) has been gradually replaced, and the LCD has become the main stream of display device. However, since the limitation of LCD device, the size of the display screen of LCD is generally lower than 30 inches. Conventionally, the plasma display panel (PDP) is developed for the display device having a screen size between 30 inches and 60 inches. However, the cost of plasma display panel (PDP) is too high to be attractive to the consumer.

Therefore, recently a large size display device has been developed using projection technology. Conventionally, the projection display apparatus may be classified into reflective projection display apparatus and rear projection display apparatus. The reflective projection display apparatus and rear projection display apparatus may include liquid crystal on silicon (LCOS) panels. Since the liquid crystal on silicon (LCOS) panel has the advantages of low-cost, high aperture ratio (up to 90%), high resolution (the pixel size may be 12 μm or less), and therefore several manufacturers are developing the LCOS panel.

In the conventional reflective projection display apparatus, a white light is provided by a light source, and then the white light is separated into red light, green light and blue light by dichroic mirrors. Then, the red light, green light and blue light are modulated to carry the red, green and blue image signals via three LCOS panels respectively. Finally, these image signals are combined by the X-cube dichroic prism to output an image and projected by the projection lens. However, since the light is separated by dichroic mirrors, the cost of the projection display apparatus is high and the design of the light path is complex. Besides, in the conventional reflective LCOS panel, an aluminium layer formed on the silicon substrate is used as a reflective layer. Thus, the reflectivity of the conventional reflective LCOS panel is limited so that the contrast and brightness of the projection display apparatus using the reflective LCOS panel are restricted.

### SUMMARY OF THE INVENTION

Accordingly, the present invention is directed to a reflective LCOS panel having high reflectivity.

The present invention is directed to a projection display apparatus having high contrast and brightness.

In the present invention, a reflective liquid crystal on silicon (LCOS) panel comprising a silicon substrate, an absorption layer, a color mirror, a transparent substrate and a liquid crystal layer is provided. The silicon substrate has a pixel array thereon. The absorption layer is disposed over the pixel array. The color mirror is disposed over the absorption layer, and the color mirror may reflect light having at least a predetermined range of wavelength and light not reflected by the color mirror is absorbed by the absorption layer. The transparent substrate having a transparent electrode thereon is disposed opposite to the silicon substrate. The liquid crystal layer is disposed between the color mirror and the transparent electrode.

According to an embodiment of the present invention, the absorption layer comprises a black absorption material. The black absorption material, for example, comprises a metal. The metal, for example, comprises titanium nitride (TiN), tungsten (W), chromium (Cr) or molybdenum (Mo).

According to an embodiment of the present invention, the color mirror is a multilayer structure. In an embodiment, the multilayer structure comprises at least a high refractive film and at least a low refractive film. Each layer of the multilayer structure can be selected from tantalum oxide, titanium oxide or silicon oxide, for example.

According to an embodiment of the present invention, the color mirror reflects one of red light, green light, blue light, cyan light, yellow light and magenta light.

According to an embodiment of the present invention, the color mirror comprises two color reflective structures so that the color mirror reflects two of red light, green light, blue light, cyan light, yellow light and magenta light.

According to an embodiment of the present invention, the color mirror comprises three color reflective structures so that the color mirror reflects three of red light, green light, blue light, cyan light, yellow light and magenta light.

According to an embodiment of the present invention, the color mirror comprises four or more color reflective structures so that the color mirror reflects four or more of red light, green light, blue light, cyan light, yellow light and magenta light.

According to an embodiment of the present invention, the color mirror reflects infrared light.

According to an embodiment of the present invention, the pixel array comprises a plurality of active devices and a plurality of pixel electrodes electrically connected to the active devices.

A projection display apparatus comprising a light source system, at least a polarization beam splitter and at least a reflective LCOS panel is also provided. The light source system provides white light. The polarization beam splitter is disposed on a transmission path of the white light. The reflective LCOS panel is as above mentioned and disposed on a transmission path of the white light after the polarization beam splitter.

According to an embodiment of the present invention, the at least a reflective LCOS panel is a single reflective LCOS panel.

According to an embodiment of the present invention, the at least a reflective LCOS panel comprises two reflective LCOS panels.

According to an embodiment of the present invention, the at least a reflective LCOS panel comprises three reflective LCOS panels.

According to an embodiment of the present invention, the at least a reflective LCOS panel comprises four or more reflective LCOS panels.

According to an embodiment of the present invention, the light source system comprises a light source and at least an optical device. The light source, for example, comprises an arc lamp, an ultra-high performance lamp, a halogen lamp or a metal halide lamp.

Accordingly, the reflective LCOS panel of the present invention has high reflectivity because light having a predetermined range of wavelength is reflected by the color mirror and light not reflected by the color mirror can be absorbed by the absorption layer. If the reflective LCOS panel is applied to a projection display apparatus, the projection display apparatus may have high brightness and contrast, and the dichroic mirror is not required.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-section view showing a reflective LCOS panel according to an embodiment of the present invention.

FIG. 2A is a top view showing a color mirror according to an embodiment of the present invention.

FIG. 2B is a top view showing a color mirror according to another embodiment of the present invention.

FIG. 2C is a top view showing a color mirror according to another embodiment of the present invention.

FIG. 3 is a drawing showing a projection display apparatus having one LCOS panel according to an embodiment of the present invention.

FIG. 4 is a drawing showing a projection display apparatus having two LCOS panels according to an embodiment of the present invention.

FIG. 5 is a drawing showing a projection display apparatus having three LCOS panels according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a cross-section view showing a reflective LCOS panel according to an embodiment of the present invention. As shown in FIG. 1, the reflective LCOS panel 100 comprises a silicon substrate 102, a pixel array 101, an absorption layer 106, a color mirror 108, a liquid crystal layer 112 and a transparent substrate 114. The pixel array 101 is disposed on the silicon substrate 102. The absorption layer 106 is disposed over the pixel array 101. The color mirror 108 is disposed over the absorption layer 106. The transparent substrate 114 having a transparent electrode 116 thereon is disposed opposite to the silicon substrate 102. The material for the transparent electrode 116 comprises indium tin oxide or indium zinc oxide, for example. The liquid crystal layer 112 is disposed between the transparent electrode 116 formed on the transparent substrate 114 and the color mirror 108 formed on the silicon substrate 102. In an embodiment, the reflective LCOS panel 100 further comprises two alignment layers 110, 118 respectively disposed between the color mirror 108 and the liquid crystal layer 112 and between the transparent electrode 116 and the liquid crystal layer 112.

In an embodiment, a plurality of active devices (not shown) have been formed on the silicon substrate 102 by sub-micron semiconductor process. In addition, a plurality of pixel electrodes 104 electrically connected with the active devices are formed over the silicon substrate 102. The material for the pixel electrodes 104 is aluminium, for example. Each pixel unit 130 is comprised of one of the active devices and one of the pixel electrodes 104. The pixel array 101 is constructed of these pixel units 130. In addition, the transparent substrate 114 opposite to the silicon substrate 102 is a glass substrate, for example. Moreover, the liquid crystal layer 112 between the transparent substrate 114 and the silicon substrate 102 can be any known and suitable liquid crystal material for the reflective LCOS panel.

In particular, the absorption layer 106 may cover the pixel electrodes 104, and the color mirror 108 is disposed on the absorption layer 106. The color mirror 108 may reflect light having at least a predetermined range of wavelength and light not reflected by the color mirror 108 is absorbed by the absorption layer 106. In other words, when light 120 emits into the color mirror 108, light 120a having at least a predetermined range of wavelength is reflected by the color mirror 108 while light 120b not reflected by the color mirror 108 is absorbed by the absorption layer 106. In an embodiment, the color mirror 108 may be disposed corresponding to the pixel electrode 104 in each pixel unit 130, and a black matrix 108a may further be disposed between the patterns of the color mirror 108. The absorption layer 106 comprises a black absorption material, such as a metal. In a preferred embodiment, the metal comprises titanium nitride (TiN), tungsten (W), chromium (Cr) or molybdenum (Mo), for example. In addition, the color mirror 108 is, for example, a multilayer structure. In an embodiment, the multilayer structure comprises at least a high refractive film and at least a low refractive film alternately stacked. The color mirror 108 of multilayer structure can reflect light having at least a predetermined range of wavelength, and light not reflected by the color mirror 108 may transmit the color mirror 108 and will be absorbed by the absorption layer 106. This can be achieved by adjusting the material and thickness of the high refractive film and the low refractive film so that the predetermined range of wavelength, such as red light, green light, blue light, cyan light, yellow light or magenta light, is reflected by the color mirror 108. In an embodiment, each layer of the multilayer structure can be selected from tantalum oxide, titanium oxide or silicon oxide. In the case, since the color mirror 108 is comprised of a multilayer structure of inorganic materials, the color mirror 108 has an advantage of good resistance to high energy light source irradiation.

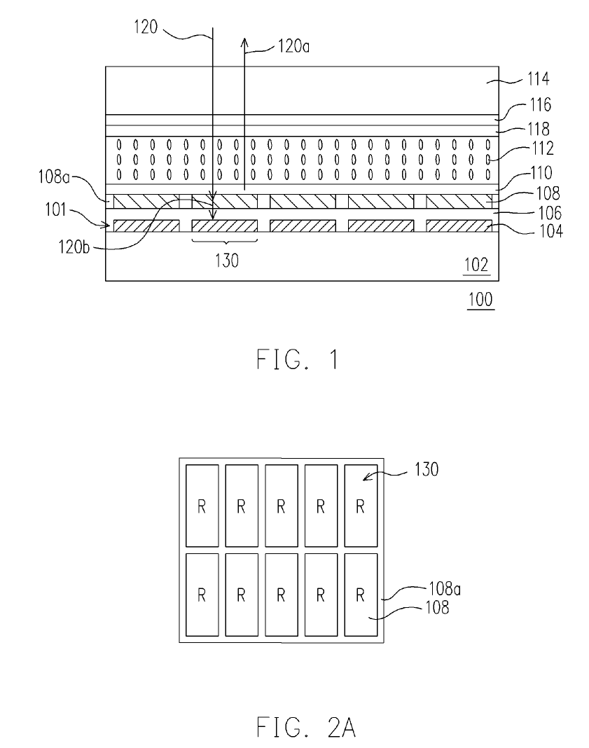

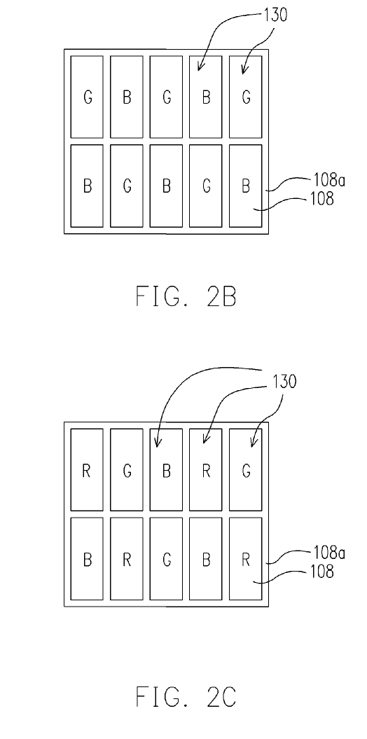

The color mirror 108 can be a single color reflective structure so that the color mirror 108 may reflect one of red light, green light, blue light, cyan light, yellow light and magenta light. FIG. 2A is a top view showing a color mirror according to an embodiment of the present invention. As shown in FIG. 2A, the color mirror 108 disposed corresponding to all of the pixel units 130 can reflect red light R. According to another embodiment, the color mirror 108 disposed corresponding to all of the pixel units 130 may reflect green light G blue light B, cyan light C, yellow light Y or magenta light M (not shown).

In another embodiment, the color mirror 108 comprises two color reflective structures so that the color mirror 108 may reflect two of red light, green light, blue light, cyan light, yellow light and magenta light. As shown in FIG. 2B, two color reflective structures which reflect green light G and blue light B are disposed corresponding to the pixel units 130 and arranged alternately. However, the arrangement of the two color reflective structures is not limited to in the present invention. Moreover, the two color reflective structures can also reflect other two color lights of red light, green light, blue light, cyan light, yellow light and magenta light (not shown in the drawing).

In another embodiment, the color mirror 108 comprises three color reflective structures so that the color mirror 108 may reflect three of red light, green light, blue light, cyan light, yellow light and magenta light. For example, as shown in FIG. 2C, the three color reflective structures reflecting red light R, green light G and blue light B are disposed corresponding to the pixel units 130 and arranged as a sequence of RBG at a first row and arranged as a sequence of BRG at a second row. However, the sequence for the three color reflective structures is not limited to in the present invention. Also, the arrangement of the three color reflective structures is not limited to in the present invention.

According to other embodiments, the color mirror 108 can be designed and fabricated to be a layer of reflecting infrared light. Alternatively, the color mirror 108 can be designed and fabricated to be a layer having four or more color reflective structures so that the color mirror 108 may reflect four or more of red light, green light, blue light, cyan light, yellow light and magenta light (not shown in the drawing).

The reflective LCOS panel of the present invention has good reflectivity because light having a predetermined range of wavelength is reflected by the color mirror and light not reflected by the color mirror can be absorbed by the absorption layer. Thus, the reflectivity of the reflective LCOS panel of the present invention is better than the conventional reflective LCOS panel using aluminium as a reflective layer.

The reflective LCOS panel can applied to the projection display apparatus having one LCOS panel, two LCOS panels, three LCOS panels, four or more LCOS panels. The detail description is as follows.

FIG. 3 is a drawing showing a projection display apparatus having one LCOS panel according to an embodiment of the present invention. As shown in FIG. 3, the projection display apparatus 300 comprises a light source system 301, a polarization beam splitter 306 and a reflective LCOS panel 100. In an embodiment, the projection display apparatus 300 further comprises a projection lens 308.

The light source system 301 can provide white light W1. The light source system 301 comprises a light source 302 and at least an optical device 304. The light source 302 comprises an arc lamp, an ultra-high performance lamp, a halogen lamp or a metal halide lamp, for example. The optical device 304 comprises a PS converter, an optical filter for filtering ultraviolet light or/and infrared light, an integrated lens, a condenser or a combination thereof.

The polarization beam splitter 306 is disposed on a transmission path of the white light W1. The reflective LCOS panel 100 is disposed on a transmission path of the white light W2 after the polarization beam splitter 306. The reflective LCOS panel 100 is as shown in FIG. 1, and the color mirror in the reflective LCOS panel 100 may reflect three of red light, green light and blue light, cyan light, yellow light and magenta light. In the case, the reflective LCOS panel 100 may reflect red light, green light and blue light R, G and B for illustration. In other words, the color mirror in the reflective LCOS panel 100 comprises three color reflective structures (as shown in FIG. 2C).

When the white light W1 provided by the light source system 301 is incident into the polarization beam splitter 306, the P or S polarized light of the white light W1 may be reflected by the polarization beam splitter 306 to form white light W2. Then, the white light W2 is incident into the reflective LCOS panel 100. Next, red light R, green light G and blue light B are reflected to the polarization beam splitter 306 by the reflective LCOS panel 100. Thereafter, the red light R, green light G and blue light B are reflected to the projection lens 308 by the polarization beam splitter 306 and then projected to a screen (not shown) and displayed as an image on the screen.

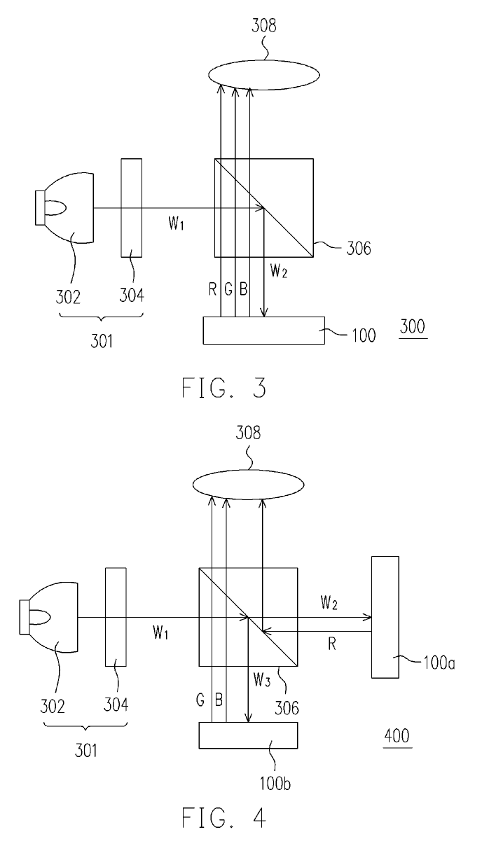

FIG. 4 is a drawing showing a projection display apparatus having two LCOS panels according to an embodiment of the present invention. As shown in FIG. 4, the projection display apparatus 400 comprises a light source system 301, a polarization beam splitter 306 and two reflective LCOS panels 100a, 100b. In an embodiment, the projection display apparatus 400 further comprises a projection lens 308.

The components of the projection display apparatus 400 similar or the same to that of the projection display apparatus 300 are not described again. In the projection display apparatus 400, two reflective LCOS panels 100a, 100b are disposed at two sides of the polarization beam splitter 306. In an embodiment, the reflective LCOS panel 100a may reflect one color light, such as red light R, and the color mirror of the reflective LCOS panel 100a is as shown in FIG. 2A. In addition, the reflective LCOS panel 100b can reflect two color lights, such as green light G and blue light B, and the color mirror of the reflective LCOS panel 100b is as shown in FIG. 2B. Also, the reflective LCOS panel 100a can be designed to have a color mirror of reflecting other color light while the reflective LCOS panel 100b is designed to have a color mirror of reflecting another two color lights.

In the case, the reflective LCOS panel 100a reflecting green light G and the reflective LCOS panel 100b reflecting red light R and blue light B are as an example for illustration. When the white light W1 provided by the light source system 301 is incident into the polarization beam splitter 306, the P or S polarized light of the white light W1 may transmit the polarization beam splitter 306 to form white light W2. The S or P polarized light of the white light W1 may be reflected by the polarization beam splitter 306 to form white light W3. Then, the white light W2 is incident into the reflective LCOS panel 100a, and red light R is reflected to the polarization beam splitter 306 by the reflective LCOS panel 100. Thereafter, the red light R is reflected to the projection lens 308 by the polarization beam splitter 306. In addition, the white light W3 is reflected to the reflective LCOS panel 100b by the polarization beam splitter 306, and then green light G and blue light B are reflected to the polarization beam splitter 306 by the reflective LCOS panel 100. Next, the green light G and blue light B may pass through the polarization beam splitter 306 to the projection lens 308. Thus, the red light R, green light G and blue light B are projected to a screen (not shown) and displayed as an image on the screen.

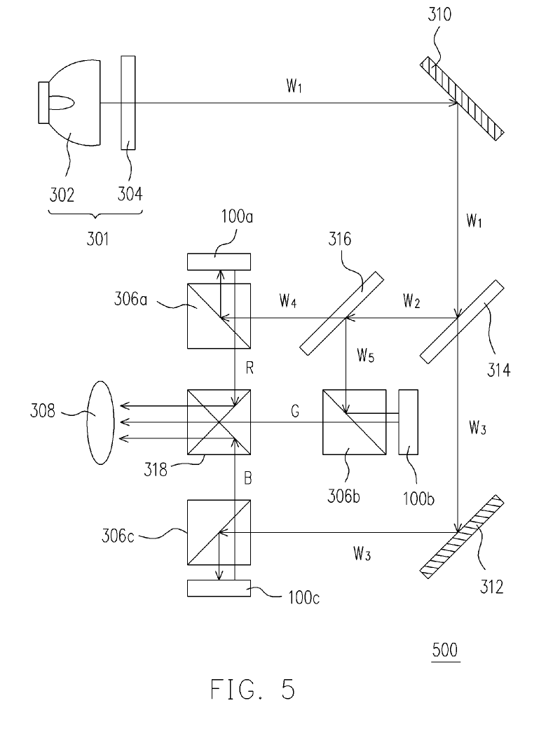

FIG. 5 is a drawing showing a projection display apparatus having three LCOS panels according to an embodiment of the present invention. As shown in FIG. 5, the projection display apparatus 500 comprises a light source system 301, polarization beam splitters 306a, 306b, 306c and three reflective LCOS panels 100a, 100b, 100c. In an embodiment, the projection display apparatus 500 further comprises reflection mirrors 310, 312, beam splitters 314, 316, an optical combiner module 318 and a projection lens 308. The components similar or the same to that of the projection display apparatus 300 are referred to the same numbers and are not described again.

The reflective LCOS panel 100a, 100b, 100c of the projection display apparatus 500 can respectively reflect one color light. In the case, the reflective LCOS panel 100a, 100b, 100c of the projection display apparatus 500 can respectively reflect red light R, green light G and blue light B for illustration. The color mirror of each reflective LCOS panel 100a, 100b, 100c comprises one color reflective structure as shown in FIG. 2A.

A white light W1 is provided by the light source 301. Then, the propagation direction of the white light W1 is changed by the reflection mirror 310. The white light W1 is separated into a reflected white light W2 and a transmitted white light W3 by the beam splitter 314.

As to the white light W3, the propagation direction of the white light W3 is changed by the reflection mirror 312. Next, the white light W3 is incident into the polarization beam splitter 306c. The P or S polarized light of the white light W3 may be reflected to the reflective LCOS panel 100c by the polarization beam splitter 306c. Thereafter, the blue light B is reflected by the reflective LCOS panel 100c and then passes through the polarization beam splitter 306c.

As to the white light W2, the white light W2 is separated into a transmitted white light W4 and a reflected white light W5 by the beam splitter 316. Next, the white light W4 is incident into the polarization beam splitter 306a. The P or S polarized light of the white light W4 may be reflected to the reflective LCOS panel 100a by the polarization beam splitter 306a. Thereafter, the red light R is reflected by the reflective LCOS panel 100a and then passes through the polarization beam splitter 306a. Similarly, the white light W5 is incident into the polarization beam splitter 306b. The P or S polarized light of the white light W5 may be reflected to the reflective LCOS panel 100b by the polarization beam splitter 306b. Thereafter, the green light G is reflected by the reflective LCOS panel 100b and then passes through the polarization beam splitter 306b.

Next, the red light R, the green light G and the blue light B are incident to the optical combiner module 318. The optical combiner module 318 comprises, for example, an X-cube dichroic prism. Then, the red light R, the green light G and the blue light B are combined and then projected to a screen (not shown) by the projection lens 308 and displayed as an image on the screen.

For the forgoing, the reflective LCOS panel of the present invention can applied be to the projection display apparatus having one LCOS panel, two LCOS panels or three LCOS panels. The reflective LCOS panel of the present invention can also be applied to the projection display apparatus having four or more LCOS panels. In particular, because the reflective LCOS panel has high reflectivity, the projection display apparatus using the same has advantages of high contrast and brightness. In addition, the dichroic mirror is not required in the projection display apparatus of the present invention, and thus the manufacturing cost for the projection display apparatus can be reduced and the design of the light path can be simplified.

If the reflective LCOS panel of the present invention is applied to the projection display apparatus having one or two LCOS panels, the projection display apparatus further has advantages of reducing the size of optical engine and further simplifying the design of the light path.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A reflective liquid crystal on silicon (LCOS) panel, comprising:
a silicon substrate having a pixel array thereon;
an absorption layer disposed over the pixel array;
a color mirror disposed over the absorption layer, wherein the color mirror reflects light having at least a predetermined range of wavelength and light not reflected by the color mirror is absorbed by the absorption layer;
a transparent substrate having a transparent electrode thereon, disposed opposite to the silicon substrate; and
a liquid crystal layer disposed between the color mirror and the transparent electrode.

2. The reflective liquid crystal on silicon panel according to claim 1, wherein the absorption layer comprises a black absorption material.

3. The reflective liquid crystal on silicon panel according to claim 2, wherein the black absorption material comprises a metal.

4. The reflective liquid crystal on silicon panel according to claim 3, wherein the metal comprises titanium nitride (TiN), tungsten (W), chromium (Cr) or molybdenum (Mo).

5. The reflective liquid crystal on silicon panel according to claim 1, wherein the color mirror is a multilayer structure.

6. The reflective liquid crystal on silicon panel according to claim 5, wherein the multilayer structure comprises at least a high refractive film and at least a low refractive film.

7. The reflective liquid crystal on silicon panel according to claim 5, wherein each layer of the multilayer structure is selected from tantalum oxide, titanium oxide or silicon oxide.

8. The reflective liquid crystal on silicon panel according to claim 1, wherein the color mirror reflects one of red light, green light, blue light, cyan light, yellow light and magenta light.

9. The reflective liquid crystal on silicon panel according to claim 1, wherein the color mirror comprises two color reflective structures so that the color mirror reflects two of red light, green light, blue light, cyan light, yellow light and magenta light.

10. The reflective liquid crystal on silicon panel according to claim 1, wherein the color mirror comprises three color reflective structures so that the color mirror reflects three of red light, green light, blue light, cyan light, yellow light and magenta light.

11. The reflective liquid crystal on silicon panel according to claim 1, wherein the color mirror comprises four or more color reflective structures so that the color mirror reflects four or more of red light, green light, blue light, cyan light, yellow light and magenta light.

12. The reflective liquid crystal on silicon panel according to claim 1, wherein the color mirror reflects infrared light.

13. The reflective liquid crystal on silicon panel according to claim 1, wherein the pixel array comprises a plurality of active devices and a plurality of pixel electrodes electrically connected to the active devices.

14. A projection display apparatus, comprising:
a light source system for providing white light;
at least a polarization beam splitter disposed on a transmission path of the white light; and
at least a reflective liquid crystal on silicon panel of claim 1, disposed on a transmission path of the white light after the polarization beam splitter.

15. The projection display apparatus according to claim 14, wherein the at least a reflective liquid crystal on silicon panel is a single reflective liquid crystal on silicon panel.

16. The projection display apparatus according to claim 14, wherein the at least a reflective liquid crystal on silicon panel comprises two reflective liquid crystal on silicon panels.

17. The projection display apparatus according to claim 14, wherein the at least a reflective liquid crystal on silicon panel comprises three reflective liquid crystal on silicon panels.

18. The projection display apparatus according to claim 14, wherein the at least a reflective liquid crystal on silicon panel comprises four or more reflective liquid crystal on silicon panels.

19. The projection display apparatus according to claim 14, wherein the light source system comprises a light source and at least an optical device.

20. The projection display apparatus according to claim 19, wherein the light source comprises an arc lamp, an ultra-high performance lamp, a halogen lamp or a metal halide lamp.
